(19) United States
(12) Patent Application Publication
(10) Pub. No.: US 2011/0221776 A1
(43) Pub. Date: Sep. 15, 2011

(54) DISPLAY INPUT DEVICE AND NAVIGATION DEVICE

(76) Inventors: Mitsuo Shimotani, Tokyo (JP); Tsutomu Matsubara, Tokyo (JP); Takashi Sadahiro, Tokyo (JP); Masako Ohta, Tokyo (JP); Yuichi Okano, Tokyo (JP); Tsuyoshi Sempuku, Tokyo (JP)

(21) Appl. No.: 13/129,533

(22) PCT Filed: Nov. 26, 2009
(86) PCT No.: PCT/JP2009/006391

§ 371 Date: May 16, 2011

(30) Foreign Application Priority Data
Dec. 4, 2008 (JP) 2008309789

(51) Int. Cl. G09G 5/00; G06F 3/041

(52) U.S. Cl. 345/647; 345/173; 345/661

(57) ABSTRACT

A display input device is comprised of a touch panel 1 for carrying out a display of an image and an input of an image, a proximity sensor 12 for detecting a movement of an object to be detected which is positioned opposite to the touch panel 1 in a non-contact manner, and a control unit 3 for, when the proximity sensor 12 detects an approach of the object to be detected to within a predetermined distance from the touch panel 1, processing an image around a display area having a fixed range on the touch panel 1 in a vicinity of the object to be detected, and displaying the image in distinction from an image in the display area having the fixed range.

### FIELD OF THE INVENTION

The present invention relates to a display input device which is particularly suitable for use in vehicle-mounted information equipment such as a navigation system.

### BACKGROUND OF THE INVENTION

A touch panel is an electronic part which is a combination of a display unit like a liquid crystal panel, and a coordinate position input unit like a touchpad, and is a display input device that enables a user to touch an image area, such as an icon, displayed on the liquid crystal panel, and detects information about the position of a part of the image area which has been touched by the user to enable the user to operate target equipment. Therefore, in many cases, a touch panel is incorporated into equipment, such a vehicle-mounted navigation system, which has to mainly meet the need for the user to handle the equipment by following a self-explanatory procedure.

Many proposals for improving the ease of use and user-friendliness of a man-machine device including such a touch panel as mentioned above have been applied for patent. For example, a display input device which, when a user brings his or her finger close to the device, enlarges and displays a key switch which is positioned in the vicinity of the finger so as to facilitate the user's selection operation (for example, refer to patent reference 1), a CRT device which detects a vertical distance of a finger and displays information with a scale of enlargement dependent upon the distance (for example, refer to patent reference 2), and a display device for and a display method of, when a button icon is pushed down, rotating button icons arranged in an area surrounding the pushed-down button icon, and gathering and displaying the button icons around the pushed-down button icon by using an animation function (for example, refer to patent reference 3) are known.

### RELATED ART DOCUMENT

Patent Reference

Patent reference 1: JP, 2006-31499, A

Patent reference 2: JP, 04-128877, A

Patent reference 3: JP, 2004-259054, A

### SUMMARY OF THE INVENTION

According to the technology disclosed by above-mentioned patent reference 1, because when a user brings his or her finger close to the touch panel, an enlarged display of an icon positioned in the vicinity of the position where the user's finger is close to the touch panel is produced, operation mistakes can be prevented and the user is enabled to easily perform an operation of selecting the icon. However, because the size of the icon which the user is going to push down varies before he or she brings the finger close to the icon, the user has a feeling that something is abnormal in performing the operation, and this may impair the ease of use of the device contrarily. Furthermore, according to the technology disclosed by patent reference 2, if the position of the finger is too far away from the touch panel surface when trying to control the scaling, the scaling sways due to a vibration in the Z axial direction of the finger, and therefore the control operation may become difficult.

In addition, according to the technology disclosed by patent reference 3, an intelligible image display can be created on the screen of a touch panel having a small display surface area for button icons. However, a drawback to this technology is that icons in a surrounding area other than the button icon pushed down are hard to be visible.

The present invention is made in order to solve the above-mentioned problems, and it is therefore an object of the present invention to provide a display input device that is easily controlled and that provides excellent ease of use which does not make the user have a feeling that something is abnormal in performing an operation.

In order to solve the above-mentioned problems, a display input device in accordance with the present invention includes: a touch panel for carrying out a display of an image and an input of an image; a proximity sensor for detecting a movement of an object to be detected which is positioned opposite to the touch panel in a non-contact manner; and a control unit for, when the proximity sensor detects an approach of the object to be detected to within a predetermined distance from the above-mentioned touch panel, processing an image around a display area having a fixed range on the touch panel in a vicinity of the above-mentioned object to be detected, and displaying the image in distinction from an image in the display area having the fixed range.

Therefore, the display input device in accordance with the present invention is easily controlled, and provides excellent ease of use which does not make the user have a feeling that something is abnormal in performing an operation.

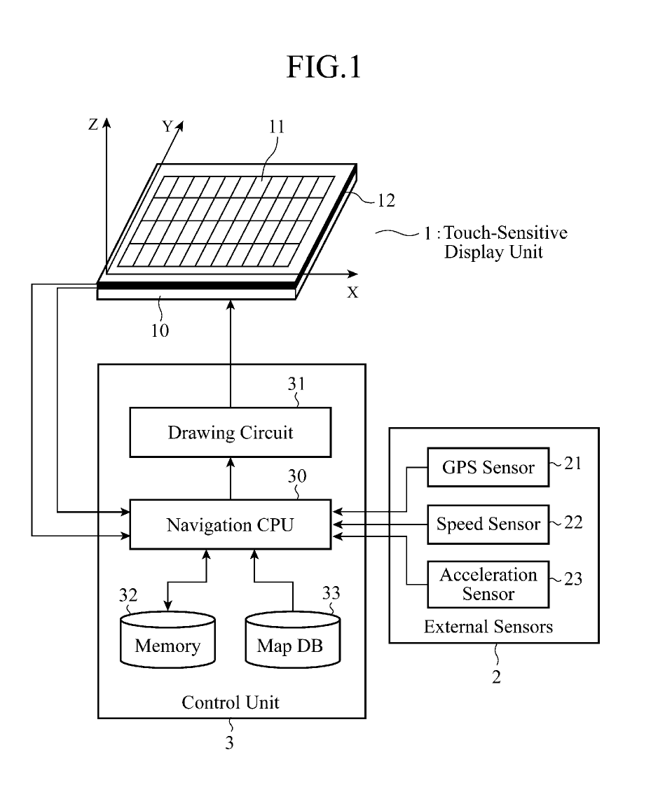

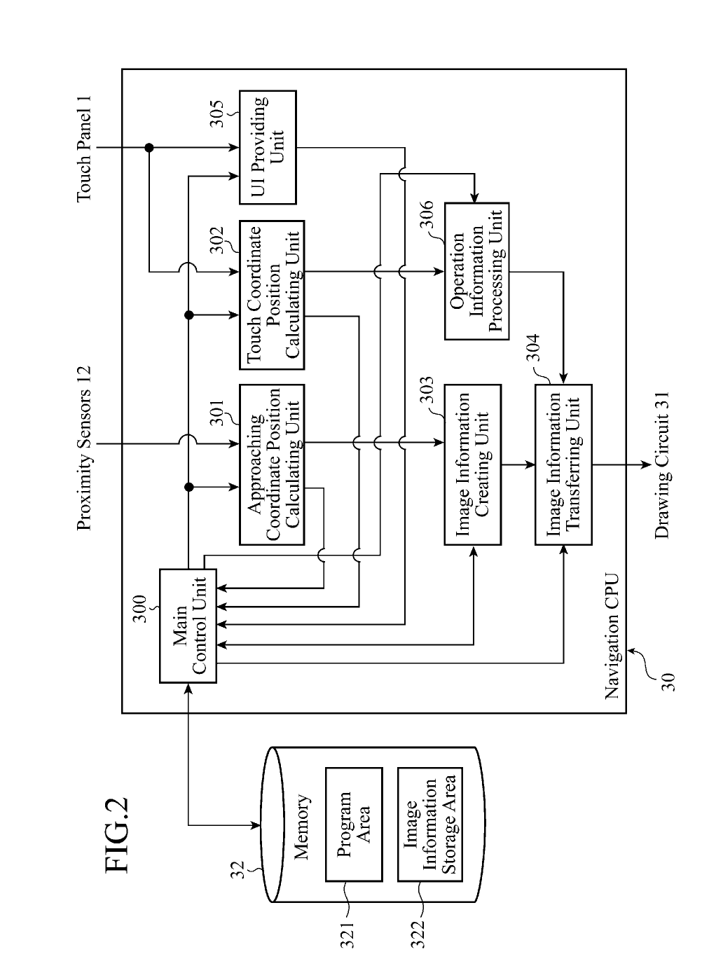

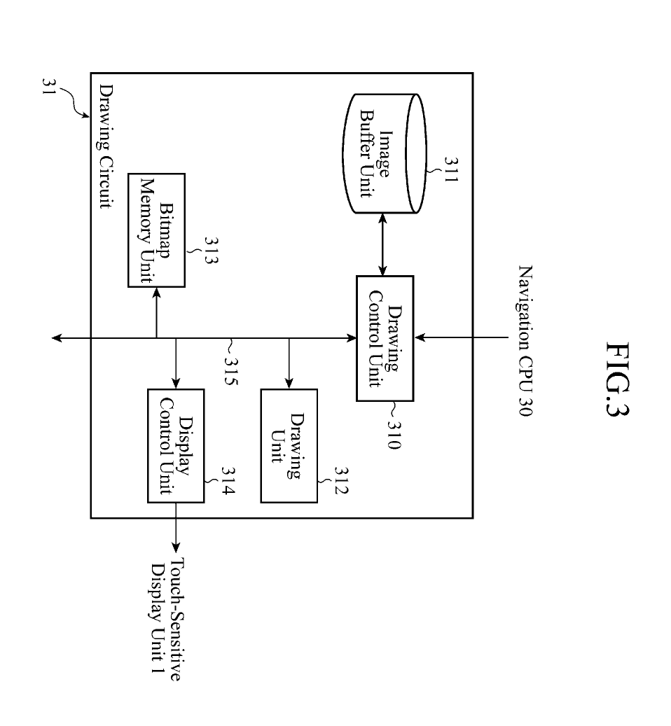

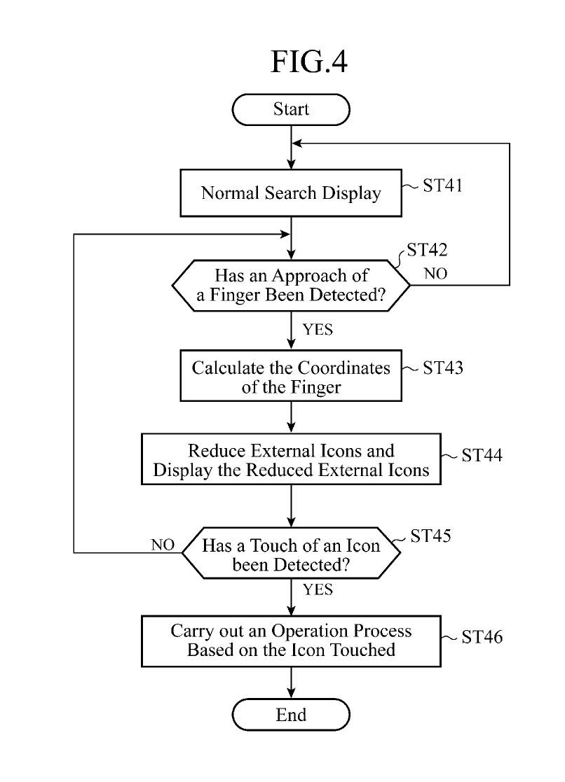

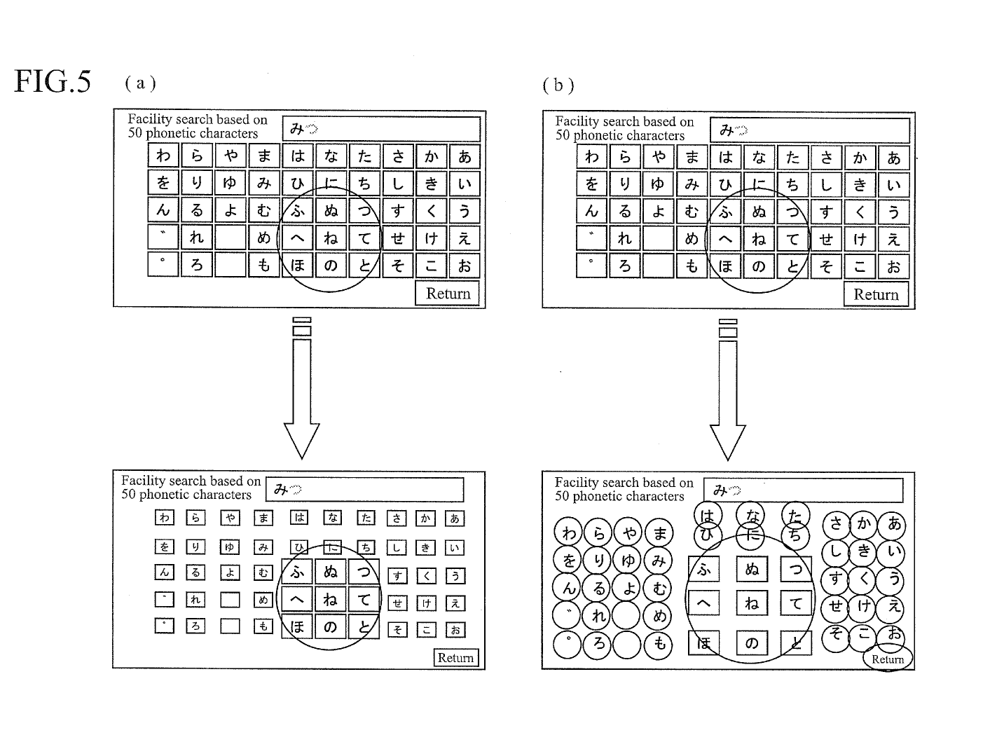

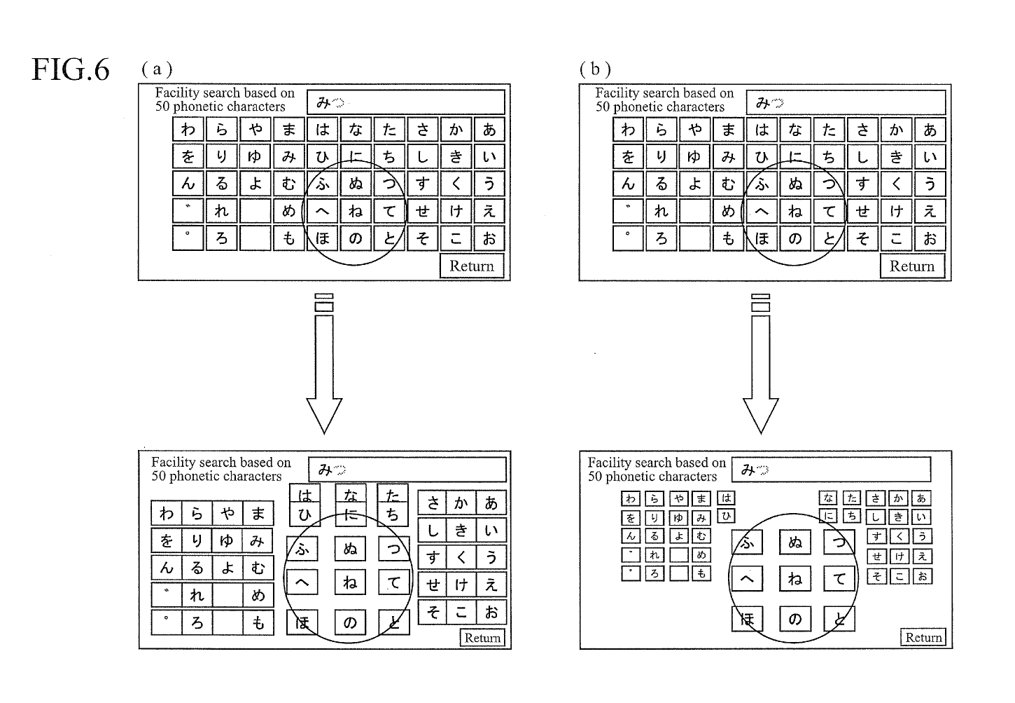

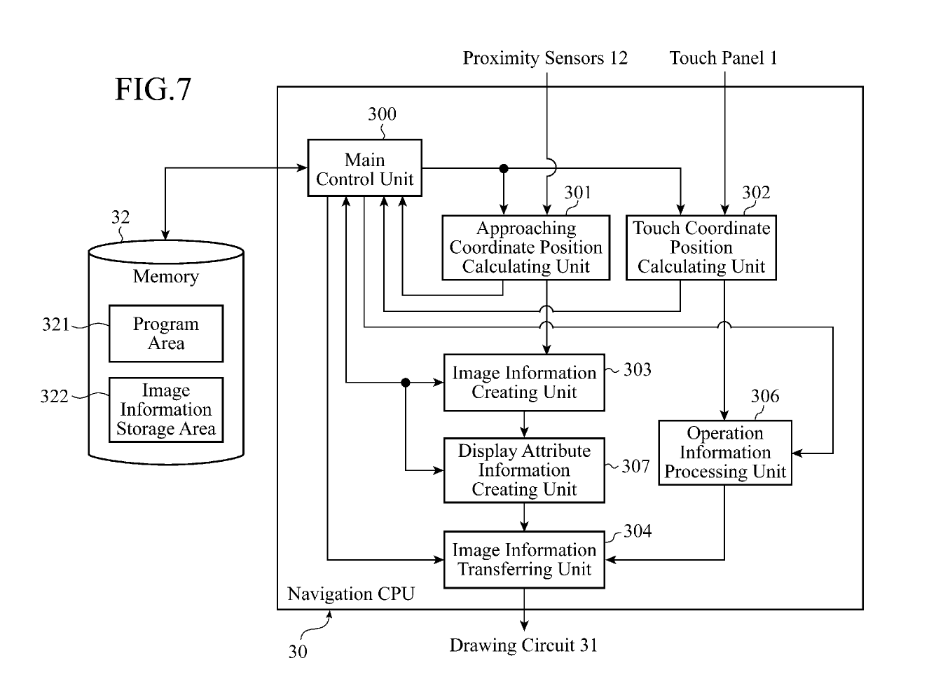

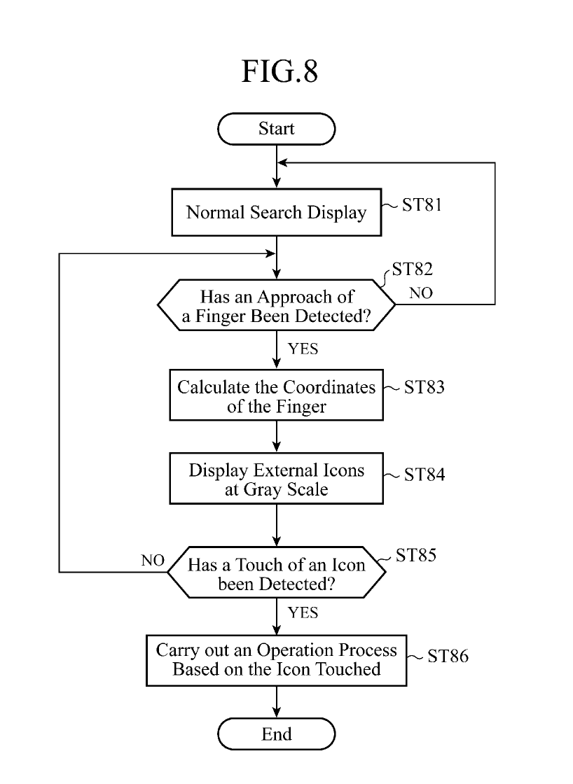

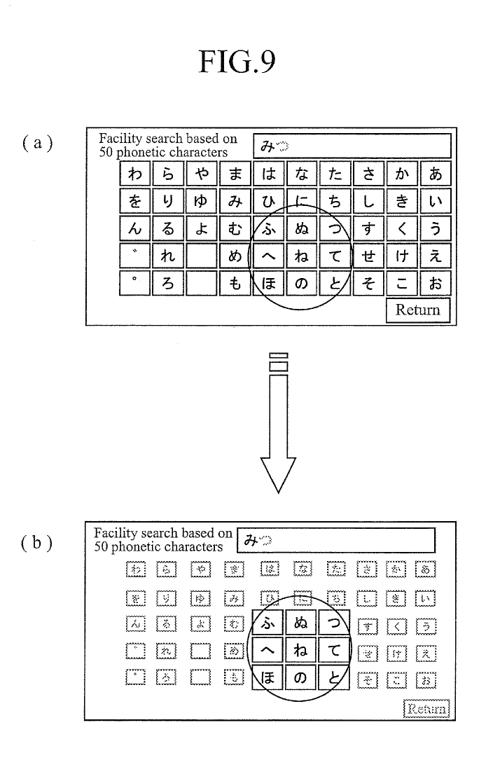

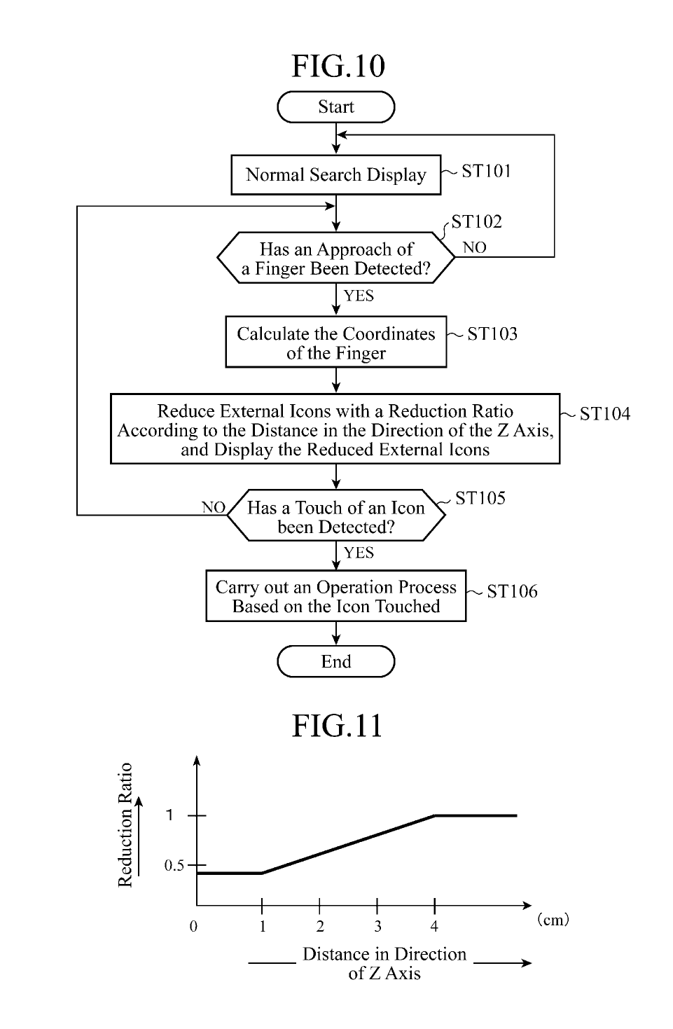

### BRIEF DESCRIPTION OF THE FIGURES

[FIG. 1] FIG. 1 is a block diagram showing the internal structure of a display input device in accordance with Embodiment 1 of the present invention;

[FIG. 2] FIG. 2 is a block diagram showing a functional development of the program structure of a navigation CPU which the display input device in accordance with Embodiment 1 of the present invention has;

[FIG. 3] FIG. 3 is a block diagram showing the internal structure of a drawing circuit which the display input device in accordance with Embodiment 1 of the present invention has;

[FIG. 4] FIG. 4 is a flow chart showing the operation of the display input device in accordance with Embodiment 1 of the present invention;

[FIG. 5] FIG. 5 is a screen transition view schematically showing an example of the operation of the display input device in accordance with Embodiment 1 of the present invention on a touch panel; [FIG. 6] FIG. 6 is a screen transition view schematically showing another example of the operation of the display input device in accordance with Embodiment 1 of the present invention on the touch panel; [FIG. 7] FIG. 7 is a block diagram showing a functional development of the program structure of a navigation CPU which a display input device in accordance with Embodiment 2 of the present invention has; [FIG. 8] FIG. 8 is a flow chart showing the operation of the display input device in accordance with Embodiment 2 of the present invention;

[FIG. 9] FIG. 5 is a screen transition view schematically showing an example of the operation of the display input device in accordance with Embodiment 2 of the present invention on a touch panel; [FIG. 10] FIG. 10 is a flow chart showing the operation of a display input device in accordance with Embodiment 3 of the present invention; and [FIG. 11] FIG. 11 is a view showing a graphical representation of the operation of the display input device in accordance with Embodiment 3 of the present invention.

### EMBODIMENTS OF THE INVENTION

Hereafter, in order to explain this invention in greater detail, the preferred embodiments of the present invention will be described with reference to the accompanying drawings.

Embodiment 1.

FIG. 1 is a block diagram showing the structure of a display input device in accordance with Embodiment 1 of the present invention. As shown in FIG. 1, the display input device in accordance with Embodiment 1 of the present invention is comprised of a touch-sensitive display unit (abbreviated as a touch panel from here on) 1, external sensors 2, and a control unit 3.

The touch panel 1 carries out a display of information and an input of the information. For example, the touch panel 1 is constructed in such a way that a touch sensor 11 for inputting information is laminated on an LCD panel 10 for displaying information. In this embodiment, the touch panel 1 and a plurality of proximity sensors 12 each of which carries out non-contact detection in two dimensions of a movement of an object to be detected, such as a finger or a pen, which is positioned opposite to the touch panel 1 are mounted on a peripheral portion outside the touch sensor 11 on a per-cell basis.

In a case in which each of the proximity sensors 12 uses an infrared ray, infrared ray emission LEDs (Light Emitted Diodes) and light receiving transistors are arranged, as detection cells, opposite to each other on the peripheral portion outside the touch sensor 11 in the form of an array. Each of the proximity sensors 12 detects a block of light emitted therefrom or reflected light which is caused by an approach of an object to be detected to detect the approach and also detects the coordinate position of the object.

The detection cells of the proximity sensors 12 are not limited to the above-mentioned ones each of which employs an infrared ray. For example, sensors of capacity type each of which detects an approach of an object to be detected from a change of its capacitance which occurs between two plates arranged in parallel like a capacitor can be alternatively used. In this case, one of the two plates serves as a ground plane oriented toward the object to be detected, and the other plate side serves as a sensor detection plane, and each of the sensors of capacity type can detect an approach of the object to be detected from a change of its capacitance formed between the two plates and can also detect the coordinate position of the object.

On the other hand, the external sensors 2 can be mounted at any positions in a vehicle, and include at least a GPS (Global Positioning System) sensor 21, a speed sensor 22, and an acceleration sensor 23.

The GPS sensor 21 receives radio waves from GPS satellites, creates a signal for enabling the control unit 3 to measure the latitude and longitude of the vehicle, and outputs the signal to the control unit 3. The speed sensor 22 measures vehicle speed pulses for determining whether or not the vehicle is running and outputs the vehicle speed pulses to the control unit 3. The acceleration sensor 23 measures a displacement of a weight attached to a spring to estimate an acceleration applied to the weight, for example. Ina case in which the acceleration sensor 23 is a three-axis one, the acceleration sensor follows an acceleration variation ranging from 0 Hz (only the gravitational acceleration) to several 100 Hz, for example, and measures the direction (attitude) of the weight with respect to the ground surface from the sum total of acceleration vectors in X and Y directions and informs the direction to the control unit 3.

The control unit 3 has a function of, when the proximity sensors 12 detect an approach of an object to be detected, such as a finger or a pen, to within a predetermined distance from the touch panel 1, processing an image outside a display area having a fixed range displayed on the touch panel 1, and displaying the image in distinction from an image in the display area having the fixed range. In this embodiment, as will be mentioned below, the control unit processes the image outside the display area having the fixed range by carrying out an image creating process with reduction, a display decoration control process with tone, color, blink, emphasis, or the like, or the like, and displays the image in distinction from the image in the display area having the fixed range.

To this end, the control unit 3 is comprised of a CPU (referred to as a navigation CPU 30 from here on) which mainly carries out navigation processing and controls the touch panel 1, a drawing circuit 31, a memory 32, and a map DB (Data Base) 33.

In this specification, assuming a case in which a software keyboard is displayed in a display area of the touch panel 1, when an object to be detected, such as a finger, is brought close to the touch panel 1, an image in “the display area having the fixed range” means an arrangement of some candidate keys one of which is to be pushed down by the object to be detected, and an image “outside the display area having the fixed range ” means an arrangement of all keys except the above-mentioned candidate keys. Therefore, in the following explanation, for convenience' sake, an image displayed in the display area having the fixed range is called “internal icons”, and an image which is displayed outside the display area having the fixed range, and which is processed in order to discriminate the image from internal icons is called “external icons”.

The navigation CPU 30 carries out a navigation process of, when a navigation menu, such as a route search menu, which is displayed on the touch panel 1 is selected by a user, providing navigation following the menu. When carrying out the navigation process, the navigation CPU 30 refers to map information stored in the map DB 33, and carries out a route search, destination guidance or the like according to various sensor signals acquired from the external sensors 2.

Furthermore, in order to implement the control unit 3′s function of, when the proximity sensors 12 detect an approach of an object to be detected, such as a finger or a pen, to within the predetermined distance from the touch panel 1, processing external icons displayed on the touch panel 1, and displaying the external icons in distinction from internal icons, the navigation CPU 30 creates image information and controls the drawing circuit 31 according to a program stored in the memory 32. The structure of the program which the navigation CPU 30 executes in that case is shown in FIG. 2, and the details of the structure will be mentioned below.

The drawing circuit 31 expands the image information created by the navigation CPU 30 on a bit map memory unit built therein or mounted outside the drawing circuit at a fixed speed, reads image information which is expanded on the bit map memory unit by a display control unit similarly built therein in synchronization with the display timing of the touch panel 1 (the LCD panel 10), and displays the image information on the touch panel 1.

The above-mentioned bit map memory unit and the above-mentioned display control unit are shown in FIG. 3, and the details of these components will be mentioned below.

An image information storage area and so on are assigned to a work area of the memory 32, which is provided in addition to a program area in which the above-mentioned program is stored, and image information are stored in the memory 32.

Furthermore, maps, facility information and so on required for navigation including a route search and guidance are stored in the map DB 33.

FIG. 2 is a block diagram showing a functional development of the structure of the program which the navigation CPU 30 of FIG. 1, which the display input device (the control unit 3) in accordance with Embodiment 1 of the present invention has, executes.

As shown in FIG. 2, the navigation CPU 30 includes a main control unit 300, an approaching coordinate position calculating unit 301, a touch coordinate position calculating unit 302, an image information creating unit 303, an image information transferring unit 304, a UI (User Interface) providing unit 305, and an operation information processing unit 306.

The approaching coordinate position calculating unit 301 has a function of, when the proximity sensors 12 detect an approach of a finger to the touch panel 1, calculating the XY coordinate position of the finger and delivering the XY coordinate position to the main control unit 300.

The touch coordinate position calculating unit 302 has a function of, when the touch sensor 11 detects a touch of an object to be detected, such as a finger, on the touch panel 1, calculating the XY coordinate position of the touch and delivering the XY coordinate position to the main control unit 300.

The image information creating unit 303 has a function of creating image information to be displayed on the touch panel 1 (the LCD panel 10) under the control of the main control unit 300, and outputting the image information to the image information transferring unit 304.

The image information creating unit 303 processes an image of external icons displayed on the touch panel 1 and displays the image in distinction from internal icons. For example, when a finger approaches the touch panel 1, the image information creating unit 303 leaves an arrangement of some candidate keys (internal icons) one of which is to be pushed down by the finger just as they are, and creates a reduced image of external icons by thinning out the pixels of an image which constructs a key arrangement except the candidate keys at fixed intervals of some pixels. The image information creating unit outputs image information which the image information creating unit composites the external icons which it has updated by thinning out the pixels of the original image at the fixed intervals and the internal icons and then creates to the drawing circuit 31 together with a drawing command. Furthermore, the image information transferring unit 304 has a function of transferring the image information created by the image information creating unit 303 to the drawing circuit 31 under the timing control of the main control unit 300. Although the method of reducing the original bitmap image by thinning out the original bitmap image is explained as an example, in a case of processing a vector image instead of a bit image, the vector image can be reduced to a more beautiful image through a predetermined reduction computation. Furthermore, an image having a reduced size can be prepared in advance and can be presented.

The UI providing unit 305 has a function of, at the time when configuration settings are made, displaying a setting screen on the touch panel 1, and capturing a user setting inputted thereto via the touch panel 1 to make a reduction ratio variable at the time of carrying out the process of reducing the image outside the display area having the fixed range according to the user setting.

The operation information processing unit 306 has a function of creating operation information defined for an icon which is based on the coordinate position of the touch calculated by the touch coordinate position calculating unit 302, outputting the operation information to the image information transferring unit 304, and then displaying the operation information on the touch panel 1 (the LCD monitor 10) under the control of the main control unit 300. For example, when the icon is a key of a soft keyboard, the operation information processing unit 304 creates image information based on the touched key, outputs the image information to the image information transferring unit 304, and then displays the image information on the touch panel 1. When the icon is an icon button, the operation information processing unit 306 carries out a navigation process defined for the icon button, such as a destination search, creates image information, outputs the image information to the image information transferring unit 304, and then displays the image information on the touch panel 1.

The work area having a predetermined amount of storage, in addition to the program area 321 in which the above-mentioned program is stored, is assigned to the memory 32. In this work area, the image information storage area 322 in which the image information created by the image information creating unit 303 is stored temporarily is included.

FIG. 3 is a block diagram showing the internal structure of the drawing circuit 31 shown in FIG. 1. As shown in FIG. 3, the drawing circuit 31 is comprised of a drawing control unit 310, an image buffer unit 311, a drawing unit 312, the bitmap memory unit 313, and the display control unit 314. They are commonly connected to one another via a local bus 315 which consists of a plurality of lines used for address, data and control.

In the above-mentioned construction, the drawing control unit 310 decodes a drawing command and carries out preprocessing about drawing of a straight line, drawing of a rectangle, the slope of a line or the like prior to a drawing process. The drawing unit 312, which is started by the drawing control unit 310, then transfers and writes (draws) the image information decoded by the drawing control unit 310 into the bitmap memory unit 313 at a high speed.

The display control unit 314 then reads the image information held by the bitmap memory unit 313 in synchronization with the display timing of the LCD panel 10 of the touch panel 1 via the local bus 315, and produces a desired display of the image.

FIG. 4 is a flow chart showing the operation of the display input device in accordance with Embodiment 1 of the present invention, and FIGS. 5 and 6 are views showing examples of change of the display of a soft keyboard image displayed on the touch panel 1.

Hereafter, the operation of the display input device in accordance with Embodiment 1 of the present invention shown in

FIGS. 1 to 3 will be explained in detail with reference to FIGS. 4 to 6.

In FIG. 4, a soft keyboard used at the time of a facility search as shown in FIG. 5(a) is displayed in a display area of the touch panel 1, for example (step ST41). In this state, when a user brings his or her finger, as an object to be detected, close to the touch panel 1 first, the proximity sensors 12 detect this approach of the finger (if “YES” in step ST42), and starts an XY coordinates computation process by the approaching coordinate position calculating unit 301 of the navigation CPU 30.

The approaching coordinate position calculating unit 301 calculates the finger coordinates (X, Y) on the touch panel 1 of the finger brought close to the touch panel 1, and outputs the finger coordinates to the main control unit 300 (step ST43).

The main control unit 300 which has acquired the finger coordinates starts an image information creating process by the image information creating unit 303, and the image information creating unit 303, which is started by the main control unit, carries out a reducing process of reducing the image of external icons on the screen except a partial area of the software keyboard which is positioned in the vicinity of the finger coordinates, and composites the image with an image of internal icons to update the image displayed on the touch panel (step ST44).

More specifically, in order to carry out the reducing process of reducing the image of the external icons displayed on the touch panel 1, the image information creating unit 303 reads the image information (the external icons) about the image of the adjacent surrounding area except the partial area (the internal icons) of the already-created soft keyboard image, as shown in a circle of FIG. 5(a), from the image information storage area 322 of the memory 32 while thinning out the image at fixed intervals of some pixels. The image information creating unit 303 then composites the reduced image with the image information about the partial area to create software keyboard image information in which the information about the partial area in the vicinity of the finger coordinate position is emphasized.

The display input device enables the user to set up the reduction ratio with which the image information creating unit reduces the image of the external icons. The display input device thus makes it possible to carryout the reducing process with flexibility, and provides convenience for the user.

Concretely, under the control of the main control unit 300, the UI providing unit 305 displays a setting screen on the touch panel 1, and captures an operational input done by the user to vary and control the reduction ratio with which the image information creating unit 303 carries out the reducing process. The setup of the reduction ratio can be carried out at the time when configuration settings are made in advance, or can be carried out dynamically according to how the display input device is used.

By the way, the image information created by the image information creating unit 303 is outputted to the image information transferring unit 304 while the image information is stored in the image information storage area 322 of the memory 32.

The image information transferring unit 304 receives the updated image information and transfers this image information, as well as a drawing command, to the drawing circuit 31, and, in the drawing circuit 31, the drawing unit 312 expands the transferred image information which the drawing circuit 31 has received and draws the expanded image information into the bitmap memory unit 313 at a high speed under the control of the drawing control unit 310. The display control unit 314 then reads the image drawn into the bitmap memory unit 313, e.g., an updated software keyboard image as shown in FIG. 5(a), and displays the image on the touch panel 1 (the LCD panel 10).

When the touch panel 1 (the touch sensor 11) detects that the finger has touched one of the icons (if “YES” in step ST45), the touch coordinate position calculating unit 302 calculates the coordinate position of the touch and starts the operation information processing unit 306. The operation information processing unit 306 then carries out an operation process based on the key corresponding to the coordinates of the touch calculated by the touch coordinate position calculating unit 302 (step ST46). In this case, the operation process based on the key corresponding to the coordinates of the touch means that, in the case in which the touched icon is a key of the soft keyboard, the operation information processing unit creates image information based on the touched key, outputs the image information to the image information transferring unit 304, and displays the image information on the touch panel 1 (the LCD monitor 10). In the case in which the touched icon is an icon button, the operation process based on the key corresponding to the coordinates of the touch means that the operation information processing unit carries out a navigation process defined for the icon button, such as a destination search, creates image information, outputs the image information to the image information transferring unit 304, and then displays the image information on the touch panel 1 (the LCD monitor 10).

As previously explained, in the display input device in accordance with above-mentioned Embodiment 1 of the present invention, when the proximity sensors 12 detect an approach of an object to be detected, such as a finger or a pen, to within the predetermined distance from the touch panel 1, the control unit 3 (the navigation CPU 30) processes an image (external icons) outside a display area having a fixed range displayed on the touch panel 1 by reducing the image, for example, and then displays the image in distinction from an image (internal icons) in the display area having the fixed range. As a result, because the display input device can emphasize the internal icons without requiring much processing load, the display input device enables the user to perform an input operation easily, thereby improving the ease of use thereof.

In accordance with above-mentioned Embodiment 1, the control unit reduces the image outside the display area having the fixed range and then displays the image in distinction from the image in the display area having the fixed range. For example, as shown in FIG. 5(b), the control unit can alternatively change the shape of each of the external icons displayed on the touch panel 1 from a quadrangular one into a circular one to display the external icons in distinction from the image of the internal icons.

As shown in FIG. 6(a), the control unit can alternatively carry out a process of narrowing the space (key space) between two or more images of external icons displayed on the touch panel 1 to display the two or more images in distinction from the image in the display area having the fixed range. As shown in FIG. 6(b), the control unit can alternatively enlarge the space between two or more images in the display area having the fixed range, and display the two or more images in distinction from the image outside the display area having the fixed range. In either of these variants, the control unit can implement the process by causing the above-mentioned image information creating unit 303 to perform the reduction or enlargement process on the image at the position at which the space among the external icons is changed to update the image.

Instead of, in step ST44, creating a reduced display of the external icons in an instant, and, in steps from ST42 to ST41 of creating a normal search display after temporarily creating a reduced display, creating reduction and enlargement displays of the external icons in an instant, the control unit can change the size of each of the external icons gradually, like in the case of an animation effect, thereby being able to provide a user-friendly operation feeling for the user. Furthermore, instead of returning the display size to a normal one immediately after the finger is far away from the touch panel, the control unit can return the display size to a normal one after a lapse of a certain time interval (e.g. about 0.5 seconds). However, when the user is moving his or her finger in the X, Y plane with the finger being close to the touch panel, the control unit preferably changes the displayed information in an instant so that the use has a better operation feeling.

In the above-mentioned embodiment, although the touch panel display that detects an approach of a finger and a touch of a finger is used, a touch panel display that detects a contact of a finger and a pushdown by a finger can be alternatively used, and the display input device can be constructed in such a way as to, when a touch of a finger is detected by the touch panel display, reduce and display external icons, when the touch is then released, return the display size to a normal one, and, when a pushdown of an icon is detected by the touch panel display, carry out a predetermined operation according to the icon.

Embodiment 2

FIG. 7 is a block diagram showing a functional development of the structure of a program which a navigation CPU 30, which a display input device (a control unit 3) in accordance with Embodiment 2 of the present invention has, executes.

The display input device in accordance with Embodiment 2 of the present invention differs from that in accordance with Embodiment 1 shown in FIG. 2 in that a display attribute information creating unit 307 is added to the program structure of the navigation CPU 30 in accordance with Embodiment 1 from which the UI providing unit 305 is excluded.

In order to process external icons displayed on a touch panel 1 to display the external icons in distinction from internal icons, the display attribute information creating unit 307 creates attribution information used to carry out display decoration control of an image according to a display attribute, such as tone, color, blink, reverse, or emphasis, for each image information created by an image information creating unit 303 under the control of a main control unit 300.

The display attribute information creating unit 307 writes and stores the display attribute information created thereby in an image information storage area 322 of a memory 32 while pairing the display attribute information with each image information created by the image information creating unit 303. Therefore, an image information transferring unit 304 transfers the pair of each image information created by the image information creating unit 303 and the display attribute information created by the display attribute information creating unit 307 to a drawing circuit 31 according to the timing control by the main control unit 300.

FIG. 8 is a flow chart showing the operation of the display input device in accordance with Embodiment 2 of the present invention, and FIG. 9 is a view showing an example of a software keyboard image displayed on the touch panel 1. Hereafter, the operation of the display input device in accordance with Embodiment 2 of the present invention will be explained with reference to FIGS. 8 and 9, particularly focusing on the difference between the operation of the display input device in accordance with Embodiment 2 and that in accordance with Embodiment 1.

In FIG. 8, a normal search display screen as shown in FIG. 9(a) is displayed on the touch panel 1, for example. Because processes (step ST81 to ST83) which are then performed after a user brings his or her finger close to the touch panel 1 until the coordinates (X, Y) of the finger are outputted to the main control unit 300 are the same as those of steps ST41 to ST43 explained in Embodiment 1, the explanation of the processes will be omitted hereafter in order to avoid a duplicate explanation.

Next, the control unit 3 (the navigation CPU 30) performs display decoration control based on display attribute information on external icons displayed on the touch panel 1, and displays the external icons in distinction from internal icons (step ST84).

Concretely, the main control unit 300 which has acquired the finger coordinates from an approaching coordinate position calculating unit 301 controls the image information creating unit 303 and the display attribute information creating unit 307 in such a way that the image information creating unit 303 creates image information in which external icons of a software keyboard positioned in the vicinity of the finger coordinates and internal icons are composited according to the acquired finger coordinates, and the display attribute information creating unit 307 creates display attribute information used for performing a gray scale process on the external icons displayed on the touch panel 1 among the image information created by the image information creating unit 303.

The image information created by the image information creating unit 303 and the display attribute information created by the display attribute information creating unit 307 are outputted to the image information transferring unit 304 while they are stored, as a pair, in the image information storage area 322 of the memory 32.

Next, the image information and the display attribute information which are transferred from the image information transferring unit 304, as well as a drawing command, are transferred to the drawing circuit 31, and the drawing circuit 31 (a drawing control unit 310) which has received the drawing command decodes the command, such as a straight line drawing command or a rectangle drawing command, and starts a drawing unit 312, and the drawing unit 312 carries out high-speed drawing of the image information decoded by the drawing control unit 310 into a bitmap memory unit 313.

Next, the display control unit 314 reads the image information held by the bitmap memory unit 313 in synchronization with the display timing of an LCD panel 10 of the touch panel 1. The display control unit 314 further performs a display decoration process with a gray scale (gradation control) on the external icons according to the display attribute information created by the display attribute information creating unit 307 and outputted by the image information transferring unit 304, and displays the external icons on the touch panel 1 (the LCD panel 10).

An example of the software keyboard displayed at this time is shown in FIG. 9.

When the touch panel 1 (the touch sensor 11) detects that the finger has touched one of the icons (if “YES” in step ST85), a touch coordinate position calculating unit 302 calculates the coordinate position of the touch and starts the operation information processing unit 306. The operation information processing unit 306 then carries out an operation process based on the key corresponding to the coordinates of the touch calculated by the touch coordinate position calculating unit 302, and ends the series of above-mentioned processes (step ST86).

As previously explained, in the display input device in accordance with above-mentioned Embodiment 2 of the present invention, when the proximity sensors 12 detect an approach of an object to be detected, such as a finger, to within the predetermined distance from the touch panel 1, the control unit 3 (the navigation CPU 30) processes an image (external icons) outside a display area having a fixed range displayed on the touch panel 1 by performing a gray scale process on the image, for example, and displays the image in distinction from an image (internal icons) in the display area having the fixed range, the display input device can emphasize the internal icons and enables the user to perform an input operation easily, thereby improving the ease of use thereof.

Although the display input device in accordance with above-mentioned Embodiment 2 displays the external icons in distinction from the internal icons by performing the gray scale process on the external icons, the display input device does not necessarily have to carry out the gradation control, and can alternatively carry out control of another display attribute, such as color, blink, reverse, or emphasis.

Embodiment 3

FIG. 10 is a flowchart showing the operation of a display input device in accordance with Embodiment 3 of the present invention. It is assumed that the display input device in accordance with Embodiment 3 which will be explained hereafter uses the same structure as the display input device shown in FIG. 1 and uses the same program structure as that shown in FIG. 2, like that in accordance with Embodiment 1.

The display input device in accordance with Embodiment 3 which will be explained hereafter is applied to a three-dimensional touch panel which can also measure the distance in a Z direction between its panel surface and a finger. More specifically, the touch panel 1 shown in FIG. 1 that can detect the position of an object in the X and Y directions is replaced by the three-dimensional touch panel that can also measure a distance in the Z direction. Because a technology of measuring a three-dimensional position is disclosed by above-mentioned patent reference 2, an explanation will be made assuming that this technology is simply applied to this embodiment.

In the flow chart of FIG. 10, a soft keyboard used at the time of a facility search is displayed on the touch panel 1, for example, like in the case of Embodiment 1 and Embodiment 2.

In this state, when a user brings his or her finger close to the touch panel 1, proximity sensors 12 detect this approach of the finger (if “YES” in step ST102), and an approaching coordinate position calculating unit 301 of a navigation CPU 30 starts. At this time, the approaching coordinate position calculating unit 301 calculates the coordinates (X, Y, Z) of the finger including the one in the direction of the Z axis, and outputs the coordinates to a main control unit 300 (step ST103).

The main control unit 300 which has acquired the three-dimensional finger coordinates determines a reduction ratio dependently upon the distance in the direction of the Z axis (in a perpendicular direction) between the finger opposite to the touch panel and the touch panel which is measured by the proximity sensors 12, and produces a reduced display of an image outside a display area having a fixed range displayed on the touch panel (step ST104).

More specifically, the image information creating unit 303 performs a reducing process of reducing external icons arranged in an area except a partial area of a software keyboard which is positioned in the vicinity of the finger coordinates on the basis of the acquired coordinates in the XY directions of the finger and according to the reduction ratio determined from the coordinate in the Z direction of the finger, and composites the external icons with internal icons to update the image displayed on the touch panel. A relationship between the distance in the Z axial direction (the horizontal axis) between the panel surface of the touch panel 1 and the finger and the reduction ratio (the vertical axis), which is used at that time, is shown in a graph of FIG. 11. As shown in FIG. 11, the reduction ratio reaches its maximum (1: display with a usual size) when the distance in the Z axial direction is 4 cm, decreases gradually as the distance in the Z axial direction decreases from 4 cm to 1 cm and hence the finger gets close to the panel surface, and the reduction ratio of the external icons hardly changes when the distance ranges from 1 cm to 0 cm and remains at 0.5 or less. The reduction ratio of 1.0 of FIG. 11 means that the original size is maintained, and the reduction ratio of 0.5 means that the size of each side is multiplied by a factor of 0.5.

When the touch panel 1 (a touch sensor 11) detects that the finger has touched one of the icons (if “YES” in step ST105), a touch coordinate position calculating unit 302 calculates the coordinate position of the touch and starts an operation information processing unit 306, and the operation information processing unit 306 then carries out an operation process based on the key corresponding to the coordinates of the touch calculated by the touch coordinate position calculating unit 302 (step ST106). These processes are the same as those of Embodiment 1 shown in FIG. 4.

In the display input device in accordance with above-mentioned Embodiment 3 of the present invention, when the proximity sensors 12 detect an approach of an object to be detected, such as a finger, to within a predetermined distance from the touch panel 1, the control unit 3 (the navigation CPU 30) reduces an image (external icons) outside a display area having a fixed range displayed on the touch panel 1 according to the reduction ratio dependent upon the vertical distance of the object to be detected which is positioned opposite to the touch panel, and displays the reduced image, the display input device can emphasize the internal icons and enables the user to perform an input operation easily, thereby improving the ease of use thereof.

The external icons do not have to be subjected limitedly to the reducing process, and the level of a display attribute of the external icons, such as a gray scale, can be changed according to the distance in the Z axial direction of the object to be detected.

As previously explained, in the display input device in accordance with anyone of Embodiments 1 to 3, when the proximity sensors 12 detect an approach of an object to be detected to within the predetermined distance from the touch panel 1, the control unit 3 processes an image (external icons) outside a display area having a fixed range displayed on the touch panel 1, and displays the image in distinction from an image (internal icons) in the display area having the fixed range, the display input device enables the user to perform an input operation easily without requiring the control unit 3 to have too much processing load, and can provide an outstanding ease of use which does not make the user have a feeling that something is abnormal in performing an operation.

In the display input device in accordance with any one of above-mentioned Embodiments 1 to 3, although only the software keyboard is explained as an example of information displayed in one or more display areas each having a fixed range, the information is not limited to the software keyboard, and can be alternatively specific information displayed in an arbitrary display area of the touch panel 1. Furthermore, although only a finger is explained as an example of the object to be detected, the object to be detected can be a pen or the like. Even in this case, the same advantages are provided.

Furthermore, in Embodiments 1 to 3 of the present invention, although only the case in which the display input device is applied to vehicle-mounted information equipment, such as a navigation system, is shown, the display input device in accordance with any one of Embodiments 1 to 3 can be applied to not only vehicle-mounted information equipment, but also an input output means for a personal computer or an FA (Factory Automation) computer, and a guiding system used for a public institution, an event site, or the like.

The functions of the control unit 3 (the navigation CPU 30) shown in FIG. 2 or 7 can be all implemented via hardware, or at least a part of the functions can be implemented via software.

For example, the data process of, when the proximity sensors 12 detect an approach of an object to be detected to within the predetermined distance from the touch panel 1, processing an image (external icons) outside a display area having a fixed range displayed on the touch panel 1, and displaying the image in distinction from an image (internal icons) in the display area having the fixed range, which is carried out by the control unit 3, can be implemented via one or more programs on a computer, or at least a part of the data process can be implemented via hardware.

### INDUSTRIAL APPLICABILITY

Because the display input device in accordance with the present invention is easily controlled, and provides excellent ease of use which does not make the user have a feeling that something is abnormal in performing an operation, the display input device in accordance with the present invention is suitable for use in vehicle-mounted information equipment such as a navigation system, and so on.

1-8. (canceled)

9. A display input device comprising:
a touch panel for carrying out a display of an image and an input of an image;
a proximity sensor for detecting a movement of an object to be detected which is positioned opposite to said touch panel in a non-contact manner; and
a control unit for, when said proximity sensor detects an approach of said object to be detected to within a predetermined distance from said touch panel, processing external icons which are an image displayed in an area except a display area having a fixed range from said object to be detected in a display area of said touch panel, but not processing internal icons which are an image displayed in said display area having the fixed range, and displaying said internal icons and said processed external icons in the display area of said touch panel.

10. The display input device according to claim 9, wherein said control unit carries out a process of reducing said external icons, and displays said external icons in distinction from said internal icons.

11. The display input device according to claim 10, wherein said control unit changes a reduction ratio which said control unit uses when carrying out the process of reducing said external icons according to a user setting inputted thereto via said touch panel.

12. The display input device according to claim 9, wherein said touch panel displays a plurality of operation keys, and said control unit carries out a process of narrowing a space among ones of said plurality of operation keys in an area except the display area having the fixed range from said object to be detected in a display area of said touch panel, and displays said ones in distinction from said internal icons.

13. The display input device according to claim 9, wherein said control unit changes a shape of each of said external icons, and displays said external icons in distinction from said internal icons.

14. The display input device according to claim 9, wherein said control unit performs a decorating process based on a display attribute on said external icons, and displays said external icons in distinction from said internal icons.

15. The display input device according to claim 9, wherein said control unit detects a vertical distance of the object to be detected which is positioned opposite to said touch panel by using said proximity sensor, and carries out a process of reducing and displaying said external icons according to a reduction ratio which varies dependently upon said vertical distance.

16. A navigation device which can be connected to a touch panel for carrying out an input of information and a display of an image, said touch panel having a proximity sensor for detecting an approach of an object to be detected in a non-contact manner and also detecting a movement of said object to be detected in a non-contact manner, said navigation device comprising:
a control unit for, when an approach of said object to be detected to within a predetermined distance from said touch panel is detected, processing external icons which are an image displayed in an area except a display area having a fixed range from said object to be detected in a display area of said touch panel, but not processing internal icons which are an image displayed in said display area having the fixed range, and displaying said internal icons and said processed external icons in the display area of said touch panel.
